(19) United States
(12) Patent Application Publication
(10) Pub. No.: US 2008/0237311 A1
(43) Pub. Date: Oct. 2, 2008

(54) APPARATUS AND METHOD FOR PRODUCING BRAISED PARTS

(75) Inventors: Wolfgang Knodler, Waiblingen (DE); Wolfgang Heeb, Schorndorf (DE); Cord Volker, Backnang (DE); Bernd Grunenwald, Nurtingen (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 11/948,200

(22) Filed: Nov. 30, 2007

(30) Foreign Application Priority Data
Dec. 1, 2006 (DE) 10 2006 057 157.6

(51) Int. Cl. B23K 31/02; F27B 9/02

(52) U.S. Cl. 228/183; 432/128

(57) ABSTRACT

The invention relates to a plant and a method for the production of soldered components, in particular of heat exchangers, from light metal, in particular from aluminum materials, under protective gas, with a continuous soldering furnace or a chamber soldering furnace, which is designed as a muffle which is formed from a muffle material.

In order to simplify and to improve the production of soldered components, the muffle is formed at least partially from a special muffle material which reacts with oxygen or with oxygen-containing compounds or binds oxygen or oxygen-containing compounds, in order to solder components consisting of light metal, in particular of aluminum materials, in a materially integral manner without the use of fluxes or with markedly reduced flux quantities.

### BACKGROUND

The invention relates to a plant and a method for the production of soldered components, in particular of heat exchangers, from light metal, in particular from aluminum materials, under protective gas, with or in a continuous soldering furnace or in a chamber soldering furnace, which is designed as a muffle which is formed from a muffle material.

In the soldering of aluminum, fluxes may be used in order to clean the soldering joints. When the fluxes are used, application is often highly complicated and cost-intensive. Furthermore, the components, after soldering, are acted upon with fluxes, which involves a complicated cleaning operation when chloridic fluxes are used. If noncorrosive fluxes are employed, this cleaning is not necessary in the case of certain products. However, the possibility of using them is restricted by the product design or increased requirements to be met by the component, in particular with regard to cleanliness and visual appearance. It is also possible to solder aluminum, free of fluxes, under a vacuum. However, for soldering under a vacuum, technically complicated and therefore costly soldering plants are required. The parts to be soldered must be absolutely clean, which can be ensured only by means of cost-intensive pretreatment.

The object of the invention is to simplify and improve the production of soldered components, in particular of heat exchangers, from light metal, in particular from aluminum materials, under protective gas, with or in a continuous soldering furnace or in a chamber soldering furnace, which is designed as a muffle which is formed from a muffle material.

### SUMMARY OF PREFERRED EMBODIMENTS

In a plant for the production of soldered components, in particular of heat exchangers, from light metal, in particular from aluminum materials, under protective gas, with a continuous soldering furnace or in a chamber soldering furnace, which is designed as a muffle which is formed from a muffle material, the object is achieved in that the muffle is formed at least partially from a special muffle material which reacts with oxygen or with oxygen-containing compounds or binds oxygen or oxygen-containing compounds, in order to solder components consisting of light metal, in particular of aluminum materials, in a material integral manner without the use of fluxes or with markedly reduced flux quantities. The special muffle material reacts with or binds the residual oxygen located in the furnace interior during operation or with corresponding oxygen-containing compounds. The furnace muffle may be formed completely or even partially, that is to say, for example, in the form of linings (complete or partial), from the special muffle material. It is thereby possible to reduce the oxygen content, which in conventional muffles lies, as a rule, in the range of 50 to 500 ppm (parts per million, to 5 to 20 ppm. The result of this is that no reoxidation impairing the soldering operation, in particular the wetting of the aluminum surface, occurs on the surface of the soldering stock. It is thus possible, without the use of fluxes, to be able to make materially integral soldered connections between solderable workpieces consisting of aluminum, in particular heat exchangers.

A preferred exemplary embodiment of the plant is characterized in that the special muffle material reacts with oxygen or with oxygen-containing compounds to form carbon monoxide or carbon dioxide.

A further preferred exemplary embodiment of the plant is characterized in that the special muffle material comprises graphite. The best results were achieved within the framework of the present invention by means of graphite.

A further preferred exemplary embodiment of the plant is characterized in that the special muffle material comprises steel and/or nickel materials and/or aluminum foams. It is possible to equip conventional manufacturing appliances with the special muffle material without major modifications. The plant according to the invention has markedly longer service lives than conventional manufacturing appliances. Moreover, the plant according to the invention requires less space than conventional plants.

A further preferred exemplary embodiment of the plant is characterized in that the special muffle material is arranged in a preheating and soldering zone of the continuous soldering furnace.

In a method for the production of soldered components, in particular of heat exchangers, from light metal, in particular from aluminum materials, under protective gas, in a continuous soldering furnace or in a chamber soldering furnace, which is designed as a muffle which is formed from a muffle material, the object specified above is achieved in that in the muffle, that it to say within the muffle, a material is arranged which reacts with oxygen or with oxygen-containing compounds or binds oxygen or oxygen-containing compounds, in order to solder components consisting of light metal, in particular of aluminum materials, in a material integral manner without the use of fluxes or with markedly reduced flux quantities. In the method according to the invention, within the muffle an article is arranged which comprises a material which reacts with oxygen or with oxygen-containing compounds or binds this or these. The method according to the invention can be implemented on a large scale without high outlay in technical terms as an alternative to soldering with noncorrosive fluxes. By means of the method according to the invention, it is possible to reduce the oxygen content, which in conventional muffles, lies, as a rule, in the range of 50 to 500 ppm (parts per million), to 5 to 20 ppm. The result of this is that no reoxidations impairing the soldering operation, in particular the wetting of the aluminum surface with solder, occur on the surface of the soldering stock. It is thus possible, without the use of fluxes, to be able to make material integral soldered connections between solderable workpieces consisting of aluminum, in particular heat exchangers.

In Nocolok soldering, as it is known, aluminum alloys are normally used with magnesium contents which are lower than or equal to 0.3 percent. By means of the method according to the invention, advantageously, even aluminum materials with higher magnesium contents than 0.3 percent, that is to say higher-strength aluminum alloys, can be soldered reliably during manufacture.

A preferred exemplary embodiment of the method is characterized in that the material reacts with oxygen or with oxygen-containing compounds or binds oxygen or oxygen-containing compounds to form carbon monoxide or carbon dioxide, in order to solder components consisting of light metal, in particular of aluminum materials, in a material integral manner without the use of fluxes or with markedly reduced flux quantities. The material is preferably graphite.

A further preferred exemplary embodiment of the method is characterized in that magnesium-containing core materials or plating materials are soldered.

A further preferred exemplary embodiment of the method is characterized in that aluminum basic materials with up to 1 percent of magnesium are soldered, in particular with up to 2 percent of magnesium are soldered.

A further preferred exemplary embodiment of the method is characterized in that aluminum/silicon basic materials, in particular aluminum/silicon basic lacquers, in particular aluminum/silicon solder materials with up to 2 percent of magnesium, are used.

A further preferred exemplary embodiment of the method is characterized in that auxiliary devices, such as, for example, soldering stands, bases and covers, are produced, for example, from graphite, and therefore oxygen-reducing materials are introduced into unchanged, that is to say standard soldering furnaces, via the normal manufacturing process.

### BRIEF DESCRIPTION OF THE DRAWINGS

FIG. 1 depicts an embodiment of a plant for production of soldered components.

FIG. 2 depicts a cross section of an embodiment of the heater and muffle configuration from the brazing zone of a plant for production of soldered components.

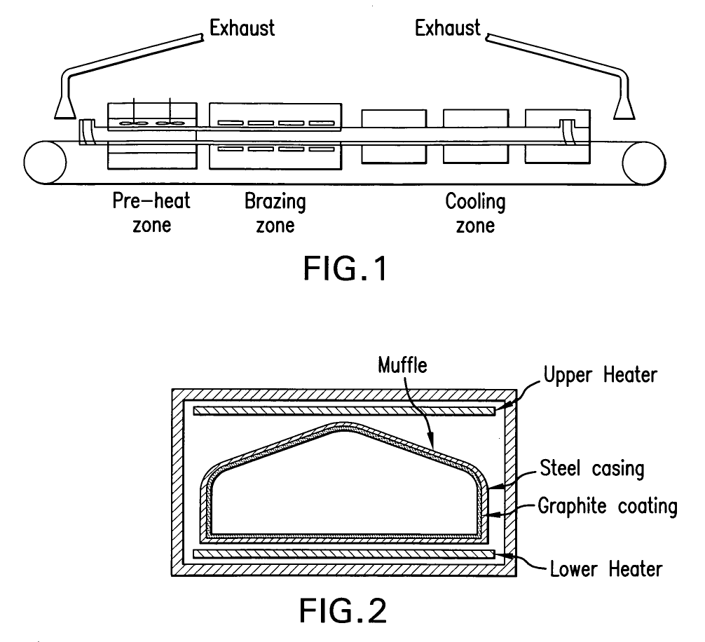

### DETAILED DESCRIPTION OF PREFERRED EMBODIMENTS

A further preferred exemplary embodiment of the method is characterized in that, during the continuous soldering process, oxygen-reducing material, in particular, for example, in the form of tension frameworks, runs through the process together with the soldering stock. In this case, in addition to the reduction in the oxygen fraction due to reaction with the material (preferably graphite, in particular carbon fiber-reinforced graphite), a reduction can be achieved via optimized furnace charging.

Further advantages, features and details of the invention may be gathered from the following description which describes various exemplary embodiments in detail. In this case, the features mentioned in the claims and in the description may be essential to the invention in each case individually in themselves or in any desired combination.

The plant according to the invention is a plant for the production of soldered heat exchangers from aluminum materials. Soldering takes place under protective gas in a continuous soldering furnace or in a chamber soldering furnace which is designed as a muffle. By specific muffle materials being used for the continuous soldering furnace or chamber soldering furnace, in particular by graphite being used, the soldering atmosphere is improved and therefore an undesirable reoxidation of aluminum is prevented.

Preferably, the furnace muffle material located in the preheating and soldering zone comprises graphite. The furnace muffle material reacts with the residual oxygen or oxygen-containing compounds located in the furnace interior, so as to form, in particular, carbon monoxide and/or carbon dioxide.

The furnace muffle may be constructed both completely and partially, that is to say, for example, in the form of linings (complete or partial), from the material reacting with residual oxygen or oxygen-containing compounds.

Furthermore, it is also possible to employ a body consisting of materials reacting with oxygen (O₂) in the furnace interior, in particular in the preheating and soldering zone. As a result, the oxygen content, which in conventional continuous soldering furnaces with muffles lies, as a rule, in the range of 50 to 500 ppm, is lowered to 5 to 20 ppm.

The result of this is that no reoxidation impairing the soldering operation, in particular the wetting of the aluminum surface with solder, occurs on the surface of the soldering stock. It is thus possible, without the use of fluxes, to be able to make materially integral soldered connections between solderable workpieces consisting of aluminum, in particular heat exchangers.

According to the present invention, the production costs for heat exchangers consisting of aluminum materials can be markedly reduced. This is attributable, inter alia, to fluxing being dispensed with. In this case, not only are the missing flux costs to be taken into account, in addition, the client costs can be reduced. Moreover, special garbage disposal which is otherwise necessary may be dispensed with. The solution according to the invention can be implemented, without major modifications, in existing manufacturing appliances. According to the present invention, substantially longer service lives of the manufacturing appliances, in particular of the furnace muffle, can be achieved. Moreover, the plant according to the invention requires less space than the conventional plants. By means of the method according to the invention, magnesium-containing materials having higher strength can be soldered. The wall thicknesses can thereby be reduced, as compared with conventional components.

1. Plant for the production of soldered components, in particular of heat exchangers, from light metal, in particular from aluminum materials, under protective gas, with a continuous soldering furnace or a chamber soldering furnace, which is designed as a muffle which is formed from a muffle material, characterized in that the muffle is formed at least partially from a special muffle material which reacts with oxygen or with oxygen-containing compounds or binds oxygen or oxygen-containing compounds, in order to solder components consisting of light metal, in particular of aluminum materials, in a material integral manner without the use of fluxes or with markedly reduced flux quantities.

2. Plant according to claim 1, characterized in that the special muffle material reacts with oxygen or with oxygen-containing compounds to form carbon monoxide or carbon dioxide.

3. Plant according to claim 1, characterized in that the special muffle material comprises graphite.

4. Plant according to claim 1, characterized in that the special muffle material comprises steel and/or nickel materials and/or aluminum foams.

5. Plant according to claim 1, characterized in that the special muffle material is arranged in a preheating and soldering zone of the continuous soldering furnace or of the chamber soldering furnace.

6. Method for the production of soldered components, in particular of heat exchangers, from light metal, in particular from aluminum materials, under protective gas, in a continuous soldering furnace or in a chamber soldering furnace, which is designed as a muffle which is formed from a muffle material, characterized in that, in the muffle, a material is arranged which reacts with oxygen or with oxygen-containing compounds or binds oxygen or oxygen-containing compounds, in order to solder components consisting of light metal, in particular of aluminum materials, in a material integral manner without the use of fluxes or with markedly reduced flux quantities.

7. Method according to claim 6, characterized in that the material reacts with oxygen or with oxygen-containing compounds or binds oxygen or oxygen-containing compounds to form carbon monoxide or carbon dioxide, in order to solder components consisting of light metal, in particular of aluminum materials, in a material integral manner without the use of fluxes or with markedly reduced flux quantities.

8. Method according to claim 6, characterized in that magnesium-containing core or plating materials are soldered.

9. Method according to claim 6, characterized in that aluminum basic materials with up to 1 percent of magnesium, in particular with up to 2 percent of magnesium, are soldered.

10. Method according to claim 6, characterized in that aluminum/silicon basic materials, in particular aluminum/silicon basic lacquers, in particular aluminum/silicon solder materials, with up to 2 percent of magnesium are used.

11. Method according to claim 6, characterized in that the auxiliary devices, such as, for example, soldering frameworks, in particular tension frameworks, bases and covers, are produced, in particular from graphite, in particular from carbon fiber-reinforced graphite, and therefore O₂-reducing materials are introduced into unchanged, that is to say standard soldering furnaces via the normal manufacturing process.

12. Method according to claim 6, characterized in that, during the continuous soldering process, O₂-reducing material runs through the process together with the soldering stock.
